(19) United States
(12) Patent Application Publication
(10) Pub. No.: US 2020/0162261 A1
(43) Pub. Date: May 21, 2020

(54) SYSTEM AND METHOD OF BLOCKCHAIN CONSENSUS MECHANISM WITH CUSTOM HARDWARE BASED ON GEOGRAPHIC DISTRIBUTION, DENSITY, NODE ASSET AND REPUTATION

(71) Applicant: Ramachandran Iyer, Arlington, TX (US)

(72) Inventor: Ramachandran Iyer, Arlington, TX (US)

(21) Appl. No.: 16/194,352

(22) Filed: Nov. 18, 2018

(51) Int. Cl. H04L 9/32; G06Q 20/38; G06Q 40/04

(52) U.S. Cl. CPC H04L 9/3236; H04L 2209/38; G06Q 40/04; G06Q 20/38215

(57) ABSTRACT

A system and method for a blockchain consensus mechanism includes a processor couple to a data bus having a blockchain protocol consensus algorithm incorporated; intelligent hardware being auto triggered and having an auto-diagnostics capability, an auto-self healing capability, and to monitor threats in a blockchain infrastructure; establishing nodes representing users and being in communication with the intelligent hardware; determining data associated with the nodes through the intelligent hardware and data bus implementing the protocol consensus algorithm, the data including geographic location, geographic density, the number of cryptographic tokens, crypto assets; and a reputation score; selecting candidate nodes to create a committee, the selection being based on the data associated with each of the nodes; selecting a leader node based on randomness; and ensuring validation of a transaction in a block so as to approve the transaction to be committed to a blockchain platform through the leader node.

### BACKGROUND

### 1. Field of the Invention

The present invention relates to a system and method of Blockchain consensus mechanism with custom hardware, based on geographic distribution, density, node asset and reputation. The system and method creates a framework along with custom hardware which allows for increased throughput of blockchain infrastructure by way of faster block time. The system includes a custom hardware device that will monitor the health of the infrastructure and also do auto diagnostics and malware prevention.

### 2. Description of Related Art

The system of the present invention relates generally to blockchain technology. Blockchain technology essentially is a chain of blocks that are cryptographically bound together and creates a logical pool of blocks which are validated by a process called consensus. A consensus algorithm is a process used to achieve agreement on a single data value among distributed processes or systems.

The Bitcoin Blockchain is well known and worked well until the Bitcoin Blockchain system became too popular, catching the attention of serious applications, and transaction numbers started increasing. The flood of applications caused the Bitcoin Blockchain system to choke, causing long delays in the process. This was no longer good enough for the multitude of blockchains to create application on such a protocol with a Proof-Of-Work consensus mechanism where nodes had to mine using computer power and actual power, which is also very detrimental. Cryptocurrencies operate on the principle of applying proof-of-work (POW) principles to process Bitcoin transactions that are bound together in large blocks of data. The device that successfully meets the proof-of-work requirements (i.e., generating a double hash value with a required number of leading zero bits) for the transaction block and has their block accepted by peers receives a reward in the form of Bitcoins.

Accordingly, the race for new ways of finding consensus started, which include the likes of Proof-Of-Stake, Proof-Of-Resource, Proof-Of-Elapsed Time, Proof-Of-Authority Proof-Of Work, Delegated Proof Of Stake, etc. However, these algorithms cannot solve common transaction performance problems. Hence there is scope for improvement in the Blockchain ecosystem.

US20170005804A1 discloses a system and method of secure provenance for distributed transaction databases. An electronic resource tracking and storage computer system is provided that communicates with a distributed Blockchain computing system that includes multiple computing nodes. The system includes a storage system, a transceiver, and a processing system. The storage system includes a resource repository and transaction repository that stores submitted Blockchain transactions. A new resource issuance request is received, and a new resource is added to the resource repository in response. A new Blockchain transaction is generated and published to the Blockchain. In correspondence with publishing to the Blockchain, the transaction storage is updated with information that makes up the Blockchain transaction and some information that was not included as part of the Blockchain transaction. The transaction storage is updated when the Blockchain is determined to have validated the previously submitted Blockchain transaction.

WO2017162904A1 discloses a management method of cryptographic transactions. According to an example aspect of the this invention, there is provided an apparatus comprising at least one processing core, at least one memory including computer program code, the at least one memory and computer program code being configured to, with the at least one processing core, cause the apparatus to compile a set of transactions in a block chain based resource management system that have taken place after the most recent block was established. The system is configured to establish a new block in the block chain, and in establishing the new block, accept messages.

U.S. Pat. No. 7,600,255 to Baugher titled “Preventing Network Denial of Service Attacks Using an Accumulated Proof-of-work Approach”. Baugher requires a computer client to generate a POW to access a service where the POW could include hashing a message until a desired number of leading bit-level zeros is found, similar to the POW of Bitcoin.

U.S. Pat. No. 8,412,952 to Ramzan et al. titled “Systems and Methods for Authenticating Requests from a Client Running Trialware Through a Proof of Work Protocol”, also uses POW to grant access to services. Ramzan describes generating a cryptographic puzzle if no authentication token is included with a service request to run trialware. The client making the request must solve the cryptographic puzzle in order to receive authentication to proceed with running the trialware.

WO2017203093A1 relates to a method for utilizing a block chain infrastructure to define a trusted circle comprising at least two nodes of a plurality of nodes, the method comprises receiving, by a first node, a notification identifying a trusted user circle comprising the first node and a second node, wherein the first node and the second node are configured to define a private block chain; and maintaining private block chain data within the trusted user circle according to pre-defined settings, wherein the private block chain data is divided between nodes of the trusted user circle based on the pre-defined settings. The block chain is protected by a proof algorithm, such as proof-of-work, proof-of-stake or the like.

U.S. Pat. No. 7,356,696 to Jakobsson et al. titled “Proofs of Work and Bread Pudding Protocols”, filed Aug. 1, 2000, describes re-using stale computations of a POW to continue minting digital currency.

US20160218879A1 relates to a system and method of providing proof of work for a block chain, the method comprising the steps of: (a) receiving in a signing device from a bookkeeping device a block, the signing device having a public/private key pair where a private key of the public/private key pair is known only by the signing device, and a public key of the public/private key pair is known by the bookkeeping device; (b) updating by the signing device a nonce field of the block; (c) creating by the signing device a digital signature for the block; (d) updating by the signing device afield in the block for storing the digital signature; (e) performing by the signing device a fitness function on the block to determine a fitness for the block to become a next block for the block chain; and (f) if the block passes the fitness function in step (e), returning by the signing device to the bookkeeping device the block as the next block in the block chain.

CN105701372A relates to identity construction and verification on the Internet, and provides a block chain identity construction and verification method. The method comprises the following steps: a certificate authority constructs a user identity block chain according to an identity verification request submitted by a user; and the certificate authority performs user identity verification processing by means of the identity block chain. According to the method provided by the present invention, user identity information is written into the block chain, and multiple certificate authorities jointly complete confirmation and storage of the identity information by means of an agreement mechanism, and then the user can conveniently perform identity verification by using the block chain. The method is not only capable of improving efficiency of user identity verification, but also will not affect accuracy of the user identity information due to the problem of an individual certificate authority, thereby greatly improving security of an identity verification process.

WO2017204943A1 discloses a method and system for an efficient consensus mechanism for permissioned Blockchains using audit guarantees. A method for addition of a block to a permissioned Blockchain using efficient consensus includes: storing a Blockchain; receiving transaction messages having transaction values from consensus nodes; generating a Merkle root for the transactions messages using transaction references; generating a proposed block header having the Merkle roof and a hash of the header of the most recently added block in the Blockchain; hashing the proposed block header; transmitting a proposal message having a digital signature and the hashed proposed block header to auditing nodes; receiving a response message accepting the digital signature from a majority of auditing nodes; transmitting an accept message to the auditing nodes; transmitting a confirmation message to the consensus nodes including the hashed proposed block header and digital signature; and writing a new block to the Blockchain having the transaction values from the transaction messages and a header including the proposed block header and digital signature.

US20170221029A1 relates to Blockchaining systems and methods for frictionless media. An ecosystem for distributing digital content over an electronic communications network includes a content creator computer system having a processor and a memory configured to store raw digital content. The system further includes computer systems for content service and for a retailer, both in operable communication with the processor. The content service computer system is configured to receive the raw digital content and transmit packaged digital content. The retailer computer system is configured to receive the packaged digital content and display its availability to an electronic device of a user. The ecosystem further includes a Blockchain in operable communication with the processor, and the content service and retailer computer systems. The Blockchain is configured to verify a transfer of the packaged digital content from the content service system to the user, a payment from the user to the retailer, and an update with information regarding the verified transfer and payment.

In view of the fact that all the prior art documents available cannot solve common transaction performance problems associated with Blockchain, the system of the present invention provides a new consensus model called Proof-Of-DiGEST, which is a way to use Distribute Geography of the nodes (computer systems) and a combination of cryptocurrency Stake along with reputation score to be able to arrive at an optimum consensus with the right balance of speed and decentralization.

The system and method of the present invention provides a way to combine geographic distribution and diversity of a computer machine (also referred to as a node), which is a proxy for the user, who is part of the blockchain framework, along with weightage based on geographic density along with weightage based on cryptographic asset that the user holds along with weightage of reputation, which is built over a period of time based on multiple parameters like, inclusion in whitelist, number of nodes validated, node uptime and other factors.

### BRIEF SUMMARY OF INVENTION

The main objective of the invention is to help to increase the performance and efficiency of block creation.

The other objective of the invention is to increase the throughput of the Blockchain infrastructure, including a custom hardware device that will monitor the health of the platform and do auto diagnostics.

One more objective of the invention to develop a new consensus model called Proof-Of-DiGEST, which is way to use Distribute Geography of the nodes (computer systems) and a combination of cryptocurrency Stake along with reputation score to be able to arrive at an optimum consensus with the right balance of speed and decentralization.

Yet another objective of the invention is to have a state of the art proof of consensus algorithm which combines a novel way of using geographically diverse and distributed locations in combination with the amount of cryptographic tokens the user holds and a combined weightage to come to a selection of candidature for every round of committee that's selected for ensuring the validation of transactions in a block, so as to be able to approve of it by the leader of the committee to be committed to the Blockchain platform.

The present invention is about a new proof of consensus algorithm (along with an auto diagnostics custom hardware) which combines a novel way of using geographically diverse and distributed location in combination with the amount of cryptographic tokens the user holds and a combined weightage to come to a selection of candidature for every round of committee that's selected for ensuring the validation of transactions in a block, so as to be able to approve of it by the leader of the committee to be committed to the Blockchain platform.

The framework also provides for a combination of Cryptographic randomness to be used for picking the leader of the committee. It is also combined with the variability and option provided for the platform administrator who is setting up the Blockchain to fine tune the parameters and configuration and changes the levers at multiple levels either during the candidature of the committee or during the election of the leader. This algorithm is a new invention which can be used by multiple Blockchain protocol to implement a fast and next-generation protocol framework.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a blockchain consensus system for establishing a committee and leader in accordance with a preferred embodiment of the present application;

FIG. 2 is a simplified schematic of components of a blockchain consensus system in accordance with a preferred embodiment of the present application;

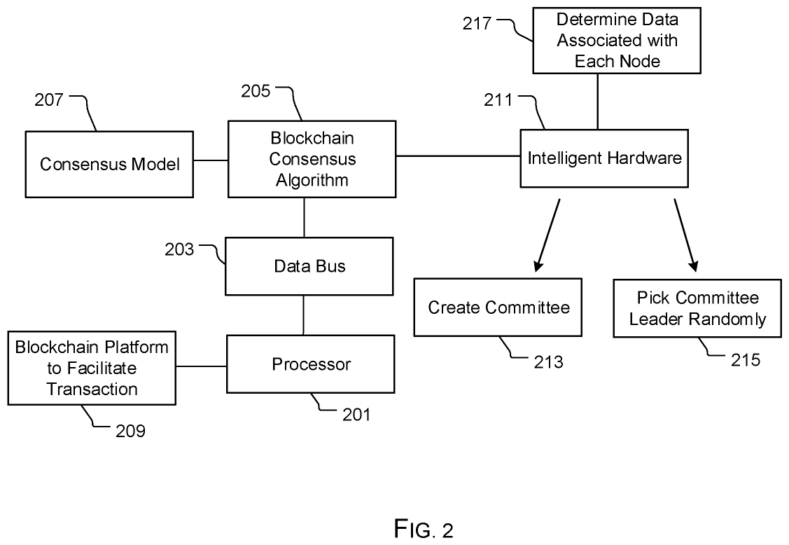

FIG. 3 is a flowchart of the method of the present system; and

FIG. 4 is a flowchart of the method of calculating a reputation in accordance with the present system.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The invention discloses a system and method of Blockchain consensus mechanism with custom hardware based on geographic distribution, density, node assets and reputation. According to our invention Proof-Of-DiGEST, which is a way to use Distribute Geography of the nodes (computer systems) and a combination of cryptocurrency Stake of the nodes along with reputation score of the nodes to be able to arrive at an optimum consensus with the right balance of speed and decentralization.

The invention also teaches creation of a new consensus algorithm, along with an auto diagnostics and self-healing custom hardware, which revolves around the fact that the current day consensus is dated. The system provides a new and faster way to achieve consensus which are dynamic and configurable. The new consensus algorithm is a function of—geographic Location, geographic node density, Cryptographic asset holding of the node, reputation score of the node. A combination of these which can be dynamically configured at the start of the platform deployment by an admin with a combined priority ranking of weightage can create a very dynamic flavor of the consensus protocol for each deployment of the system, which is very unique.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

The following definitions apply:

NODES: Nodes are any general purpose computer machines which register and become part of the Blockchain ecosystem associated with a blockchain platform. The Nodes can register by themselves if the node is part of the public instance of the Blockchain protocol or they will get invited if they are part of the permissioned instance of the Blockchain system.

CANDIDATES: Candidates are nodes that form a Committee. Candidates are selected based on their geographic distribution, associated geographic density, associated cryptographic asset and associated reputation score. This selection is achieved through system components and algorithms.

LEADER: Leader is a node that is elected automatically (software logic). In this case they are either elected through a cryptographic Lottery mechanism or as a randomized pick basis. The Leader once picked will be authorized and responsible for committing the block to the Blockchain.

CRYPTO-ASSET: Crypto-Asset is the associated token that the user/node is ready to stake as part of the Blockchain system. The crypto-asset forms one of the variables in the weighted scheme of things, when the leader is picked.

REPUTATION-SCORE: Reputation score of a node is built over a period of time and is based on multiple factors, which includes—node uptime, number of blocks validated, number of node listings, nodes in black-list, and holding time of crypto asset. The weightage on each can be tweaked based on platform need and use-case. The tweaking can be achieved via an administrator.

The system of the present invention discloses a blockchain consensus mechanism with custom hardware based on geographic distribution, density; node asset and reputation.

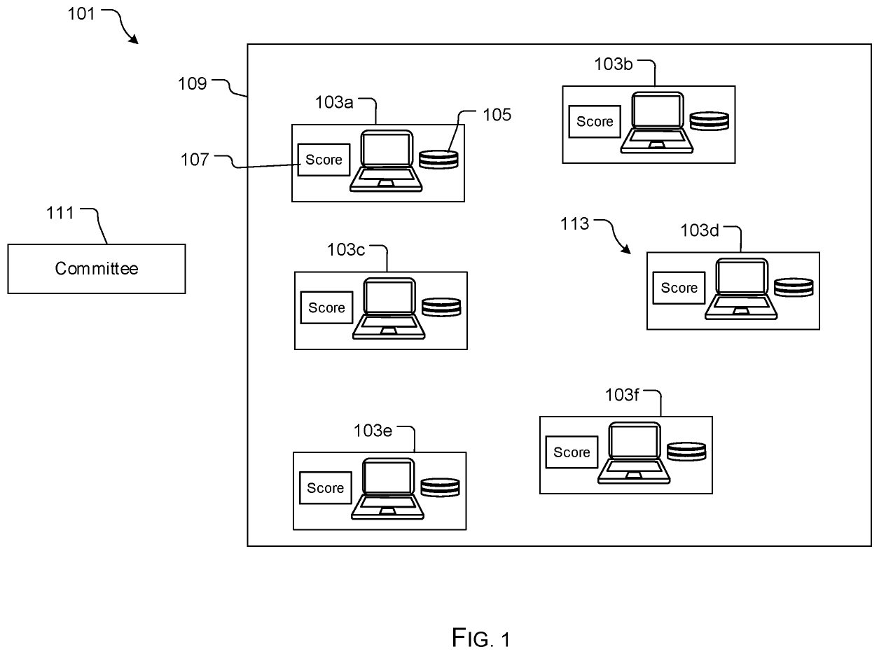

Referring now to the drawings wherein like reference characters identify corresponding or similar elements throughout the several views, FIG. 1 depicts a schematic of the architecture of a system 101 of the present invention.

In the contemplated embodiment, system 101 includes a plurality of nodes 103a-f that represent users. The plurality of nodes are associated with computing devices. Each user/node can have associated crypto assets 105 and a reputation score 107, which will be discussed herein. The plurality of nodes are configured to communicate with a processor 201 and are dispersed throughout a geographical area 109.

The processor 201 (not shown in FIG. 1), along with an associated data hub 203, a blockchain consensus algorithm 205, a consensus model 207, a blockchain platform 209, and an intelligent hardware 211 (system components), are configured to create a committee 111 (shown with box 213) through selection of one or more nodes 103 (candidates), based on a plurality of data, as will be described herein. Further, the system components are configured to randomly select a leader 113 (shown with box 215) for verification and authentication of a blockchain transaction being facilitated through the blockchain platform.

The intelligent custom hardware is configured to be auto triggered, has auto-diagnostics capability, auto-self-healing capability and can continue to do threat monitoring in the Blockchain infrastructure, that combines a novel way of using geographic location, geographic density in combination with the amount of cryptographic tokens, crypto assets the user holds and a combined weightage, to create the score of each node, to facilitate a selection of candidates for every round of committee 111.

The committee 111 is selected for ensuring the validation of transactions in a block, so as to be able to be approved of it the leader 113 of the committee 111 and to be committed to the Blockchain platform.

The system components utilize Cryptographic randomness for picking the leader of the committee, wherein candidates are the plurality of nodes, each of the plurality of nodes associated with any general-purpose machine. The leaders are nodes that are elected automatically through software logic and the Crypto-Asset 105 is the associated token that a user/node is ready to stake as part of the Blockchain system which can be custom configured by an administrator, based on the use-case and type of Blockchain

The plurality of data associated with each node is determined via the intelligent hardware 211, as shown with box 217. The data can include one or more of geographic location, geographic density, the number of cryptographic tokens, crypto assets; and a reputation score associated with each node.

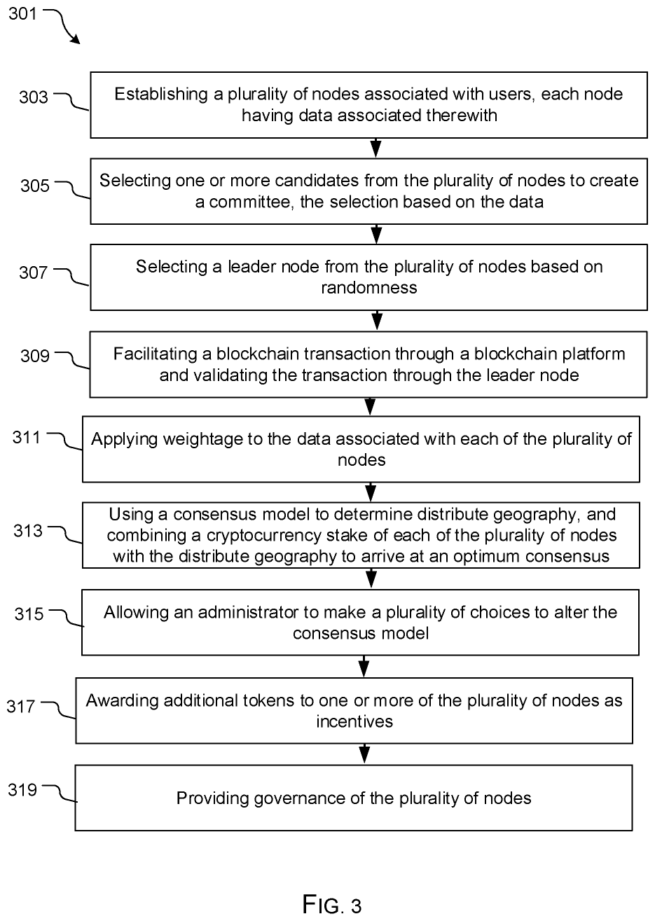

As shown in FIG. 3, a simplified flowchart 301 further depicts the method blockchain consensus associated with the present invention. The method includes establishing a plurality of nodes associated with users, each node having data associated therewith, and each of the plurality of nodes being registered within the blockchain platform, as shown with box 303. The system components are configured to select one or more candidates from the plurality of nodes to create a committee, the selection based on the data, the data including a reputational score, as shown with box 305.

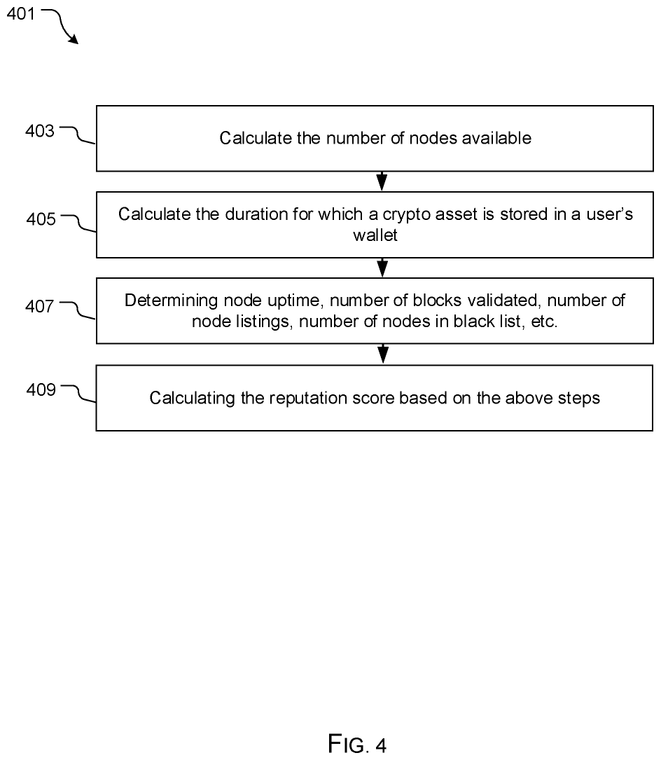

Now referring to flowchart 401 in FIG. 4, the method of establishing the reputational score of each of the plurality of nodes is shown. The score is calculated by determining the number of nodes available and the duration for which a crypto asset is stored in a user's wallet, as shown with boxes 403, 405. In addition, factors including node uptime, number of blocks validated, number of node listings, number of nodes in black list, etc., can be used, as shown with box 407. This data is used by the intelligent hardware to determine the reputational score of the associated node, as shown with box 409.

Referring back to flowchart 301, the intelligent hardware and data bus are configured to randomly select a leader node, as shown with box 307. As a transaction is facilitated through the blockchain platform, the transaction is validated through the leader node, as shown with box 309 and described in more detail below.

It should be appreciated that the system is further configured to apply weightage to the data associated with each of the plurality of nodes, thereby placing more emphasis on one or more of the data, as shown with box 311.

The system further uses a consensus model implemented through the system components to determine distribute geography, and combine a cryptocurrency stake of each of the plurality of nodes with the distribute geography to arrive at an optimum consensus, as shown with box 313.

Additional features include the ability of a system administrator to make selections and choices in order to alter the consensus model, as shown with box 315. Further, the system can award additional tokens to one or more of the plurality of nodes as incentives, as shown with box 317. And lastly, the system can provide governance of the plurality of nodes, as show with box 319.

This invention is about a combination of 2 things, which helps to increase performance and efficiency of block creation and hence increased throughput of the Blockchain infrastructure, including a custom hardware device that will monitor the health of the platform and do auto diagnostics.

One of them relates to a new proof of consensus algorithm which combines a novel way of using geographically diverse and distributed location in combination with the amount of cryptographic tokens the user holds and a combined weightage to come to a selection of candidature for every round of committee that's selected for ensuring the validation of transactions in a block, so as to be able to approve of it by the leader of the committee to be committed to the Blockchain platform.

The framework also provides for a combination of Cryptographic randomness to be used for picking the leader of the committee.

The above is also combined with the variability and option provided for the platform administrator who's setting up the Blockchain to fine tune the parameters and configuration and changes the levers at multiple levels either during the candidature of the committee or during the election of the leader.

According to an aspect of the invention, Blockchain Protocol consensus algorithm is coupled with auto-diagnostics and auto-healing custom hardware, by way of using primary factors as geographic location, geographic density and allocating a weightage on each, which can be custom configured by an administrator, based on the use-case and type of Blockchain.

According to another aspect of the invention, the intelligent custom hardware used in the system automatically invoke a program or function as the need arises (auto triggering) and detect errors in the internal organization when using multiple input data sets (auto-diagnostics capability), and makes necessary adjustments to restore itself to normal operation whenever the system is not operating as perceived (auto-self-healing) and can continue to do threat monitoring in the Blockchain infrastructure.

According to yet another aspect of the invention, the intelligent custom hardware, works seamlessly with the consensus algorithm to achieve smart diagnostic and tamper-proof capability to ensure all actors in the platform act in coordination, consensual and non-destructive manner.

According to an aspect of the invention, Blockchain Protocol consensus algorithm by way of using secondary factors as holding of cryptographic asset and reputation score and allocating a weightage on each, which can be custom configured by an administrator, based on the use-case and type of Blockchain.

According to another aspect of the invention, Blockchain Protocol consensus algorithm by way of combining both primary and secondary factors of—geographic location, geographic density, cryptographic asset holding and reputation score together and allow custom configuration at the platform installation time.

According to one aspect of the invention, mechanism of calculating the reputation score of a node or user is by using multiple factors like number of nodes validated, duration for which crypto asset is stored in user wallet dedicated to the said node.

According to an aspect of the invention, mechanism of calculating the crypto weightage is based on the amount of crypto held and for the duration it is held. This will have a relative weightage compared to the other factors while election process.

According to yet another aspect of the invention, mechanism of election process is carried out by way of combining 2 sub-set of mechanism—1) electing the candidates for the election of the committee and 2) electing the leader of the committee for validating the block in play.

According to an aspect of the invention, a mechanism is in place to 5 incentivize the right behavior by awarding additional bonus tokens for validators or notes who have a higher reputation score.

According to an aspect of the invention, mechanism is provided to dynamically change the incentive scheme for awarding bonus tokens or increased probability for being elected in a committee, based on administrator input.

According to one more aspect of the invention, there is a mechanism to dynamically change the incentive scheme for awarding bonus tokens or increased probability for being elected in a committee, based on prevailing governance model built into the system.

According to an aspect of the invention, mechanism allows interoperability between multiple consensus models and allows to interplay and inter-use Proof-Of-DiGEST.

According to another aspect of the invention, mechanism for Proof-Of-DiGEST consensus model which is in place is flexible, adaptable and extensible by allowing for easier updates and upgrades without downtime of the platform.

According to an aspect of the invention, system of governance which is baked as part of the protocol allows for nodes to follow the said rules and regulations in a coded, smart contract level.

According to one aspect of the invention, system of governance can be altered or modified by allowing flexibility for committee to propose the said changes and dynamically update the new governance model at the start of the new block.

According to yet another aspect of the invention, mechanism of consensus allows for homogenous participation for geographically dispersed nodes and creating more decentralization.

According to one aspect of the invention, mechanism of consensus does not solely depend upon cryptocurrency asset as a means of achieving higher probability for being picked in the candidature of the new committee for block validation.

According to an aspect of the invention, mechanism of consensus does not solely depend upon reputation score as a means of achieving higher probability for being picked in the candidature of the new committee for block validation.

According to yet another aspect of the invention, mechanism of consensus does not depend upon type of machine or amount of RAM as a means of achieving higher probability for being picked in the candidature of the new committee for block validation.

According to an aspect of the invention mechanism of consensus does not solely depend upon cryptocurrency asset and the storage duration as a means of achieving higher probability for being picked in the candidature of the new committee for block validation.

According to one aspect of the invention, mechanism of consensus does not solely depend upon most number of blocks validated as a means of achieving higher probability for being picked in the candidature of the new committee for block validation.

According to an aspect of the invention, mechanism provides multi-level parameters to fine-tune to increase the sensitivity on decentralization. According to another aspect of the invention, mechanism provides multi-level parameter to fine-tune to increase the efficiency and throughput of the platform for higher TPS (Transaction per second).

According to one more aspect of the invention, mechanism of provides administrative control to change the block size (total number of transactions) dynamically, if the conditions demand of the same.

According to an aspect of the invention, mechanism of internal governance changes the block size (total number of transactions) dynamically, based on internal set threshold and triggers.

According to yet another aspect of the invention, mechanism provides 10 administrative control to change the block creation time dynamically, if the conditions demand of the same.

According to an aspect of the invention, mechanism of internal governance changes the block creation time dynamically, based on internal set threshold and triggers.

This algorithm is a new invention which can be used by multiple Blockchain protocol to implement a fast and next-generation protocol framework.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system to achieve a blockchain consensus mechanism, the system comprising:
a processor in communication with a data bus;
the data bus coupled to the processor and having a blockchain protocol consensus algorithm incorporated therein;
an intelligent hardware coupled to the data bus, the intelligent hardware being auto triggered and having an auto-diagnostics capability, an auto-self healing capability, and configured to monitor threats in a blockchain infrastructure; and
a plurality of nodes configured to communicate with the intelligent hardware;
wherein the intelligent hardware and data bus are configured to implement the blockchain protocol consensus algorithm to determine data associated with the plurality of nodes, the data including geographic location, geographic density, the number of cryptographic tokens, crypto assets; and a reputation score;
wherein the intelligent hardware and data bus are configured to implement the blockchain protocol consensus algorithm to select one or more candidate nodes from the plurality of nodes to create a committee, the selection being based on the data;
wherein the intelligent hardware and data bus are configured to select a leader node from the plurality of nodes, the selection of the leader node being based on randomness;
wherein the leader node is configured to ensure validation of a transaction in a block so as to approve the transaction to be committed to a blockchain platform; and
wherein each of the plurality of nodes is a proxy for a user.

2. The system of claim 1, wherein each of the plurality of nodes is a computer machine registered with the blockchain platform.

3. The system of claim 1, wherein the crypto asset is an associated token that a user associated with one of the plurality of nodes has elected to stake within the blockchain platform.

4. The system of claim 1, wherein the reputation score is a score associated with each of the plurality of nodes that is built over time based on a plurality of factors including node uptime, number of blocks validated, number of node listings, nodes in black list, and holding time of one or more crypto assets.

5. The system of claim 4, wherein the factors are each weighted and can be manipulated based on platform need.

6. The system of claim 1, wherein the intelligent hardware is configured to achieve smart diagnostic and tamper proof capability to ensure all actors in the blockchain platform act in coordination and in a consensual, and non-destructive manner.

7. The system of claim 1, wherein the blockchain protocol consensus algorithm is configured to be manipulated by an administrator to alter an impact of each of the data on the selection of the candidates.

8. The system of claim 1, further comprising:
a consensus model implemented through the intelligent hardware and data bus;
wherein the consensus model is configured to determine distribute geography of the plurality of nodes;
wherein the consensus model is configured to combine a cryptocurrency stake of each of the plurality of nodes and the reputation score of each of the plurality of nodes with the distribute geography of the plurality nodes to arrive at an optimum consensus that allows interoperability between multiple consensus models and also allows interplay and inter-use of the consensus model.

9. The system of claim 8, wherein the consensus model includes multi-level parameters that are configured to provide fine-tune adjustments to increase sensitivity on centralization of the blockchain platform as well as efficiency of the blockchain platform, thereby allowing for higher transaction per second.

10. A method of implementing a blockchain consensus mechanism, the method comprising:
providing a processor in communication with a data bus, the data bus coupled to the processor and having a blockchain protocol consensus algorithm incorporated therein, the data bus further coupled to an intelligent hardware, the intelligent hardware being auto triggered and having an auto-diagnostics capability, an auto-self healing capability, and configured to monitor threats in a blockchain infrastructure;
establishing a plurality of nodes, each of the plurality of nodes representing a user and being in communication with the intelligent hardware;
determining data associated with the plurality of nodes through the intelligent hardware and data bus implementing the blockchain protocol consensus algorithm, the data including geographic location, geographic density, the number of cryptographic tokens, crypto assets; and a reputation score;
selecting one or more candidate nodes form the plurality of nodes to create a committee, the selection being based on the data associated with each of the plurality of nodes;
selecting a leader node from the plurality of nodes based on randomness; and
ensuring validation of a transaction in a block so as to approve the transaction to be committed to a blockchain platform through the leader node;
wherein each of the plurality of nodes is a proxy for a user.

11. The method of claim 10, wherein each of the plurality of nodes is a computer machine registered with the blockchain platform.

12. The method of claim 10, further comprising:
configuring and allocating weightage for geographic location, geographic density, holding of cryptographic asset, and reputation score for each of the plurality of nodes based on a use case and type of blockchain.

13. The method of claim 10, further comprising:
implementing a consensus model through the intelligent hardware and data bus;
determining distribute geography of the plurality of nodes with the consensus model; and
combining, through the consensus model, a cryptocurrency stake of each of the plurality of nodes and the reputation score of each of the plurality of nodes with the distribute geography of the plurality nodes to arrive at an optimum consensus that allows interoperability between multiple consensus models and also allows interplay and inter-use of the consensus model.

14. The method of claim 10, further comprising:
providing a plurality of choices to an administrator, the plurality of choices configured to alter to consensus model based on a need, a use, and a type of blockchain associated with the blockchain platform.

15. The method of claim 10, further comprising:
calculating the reputation score of each of the plurality of nodes by using multiple factors including number of nodes validated, duration for which a crypto asset is stored in a wallet associated with each of the plurality of nodes.

16. The method of claim 10, further comprising:
awarding one or more additional tokens to one or more of the plurality of nodes as incentives to users of the one or more of the plurality of nodes;
wherein the awarding of one or more additional tokens to one or more of the plurality of nodes increases a probability of the one or more of the plurality of nodes of being selected as part of the committee.

17. The method of claim 10, further comprising:
providing governance of the plurality of nodes;
wherein the governance provides one or more rules, regulations, and codes to be followed by all of the plurality of nodes.
